(19) United States
(12) Patent Application Publication
(10) Pub. No.: US 2008/0320199 A1
(43) Pub. Date: Dec. 25, 2008

(54) MEMORY AND CONTROL APPARATUS FOR DISPLAY DEVICE, AND MEMORY THEREFOR

(75) Inventors: Jung-Ping Yang, Hsinchu County (TW); Hsing-Chien Yang, Taichung City (TW); Ching-Wen Lai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/017,347

(22) Filed: Jan. 22, 2008

(30) Foreign Application Priority Data
Jun. 21, 2007 (TW) 96122301

(51) Int. Cl. G06F 13/14; G06F 12/00

(52) U.S. Cl. 710/305; 711/161; 711/E12.001

(57) ABSTRACT

A memory and control apparatus and a memory for a display device are provided. The memory and control apparatus includes a memory, a sense-latch circuit, and a timing and memory controlling apparatus. The memory is used for storing data. The memory has a display data bus and a general data bus. The sense-latch circuit is used for sensing and latching the data on the display data bus. The timing and memory controlling apparatus is used for controlling the memory, so as to make the display data represented on the display data bus, and to make the sense-latch circuit outputting the data on the display data bus. When the display device intends to store the data in the memory, the data on the general data bus is stored to the memory.

### CROSS-REFERENCE TO RELATED APPLICATION

This application claims the priority benefit of Taiwan application serial no. 96122301, filed on Jun. 21, 2007. The entirety of the above-mentioned patent application is hereby incorporated by reference herein and made a part of this specification.

### BACKGROUND OF THE INVENTION

1. Field of the Invention

The present invention relates to a display device. More particularly, the present invention relates to a memory and control apparatus and a memory for a display device.

2. Description of Related Art

In early 1970s, liquid crystal display devices were first applied in electronic digital computers, and electronic watches and clocks. Thereafter, the liquid crystal display devices are widely applied in TV sets, mobile phones, notebook computers, personal digital assistances (PDA), and the like, as various new photoelectric effects are discovered and the driving technique is improved.

FIG. 1 is a block diagram of a conventional data driving circuit for a display device. Referring to FIG. 1, in the architecture of a memory and control apparatus 110, a memory 101 in a digital display device system is employed for storing data. It should be noted that a data output path and an external data input path in the memory 101 are accomplished through a general data bus GDBus of the memory 101.

In addition, the data read out from the memory 101 cannot be directly transmitted to the display panel. The display data is first subjected to a logic operation of a shift register 103, and then processed and transmitted by a line latch 121, a level shifter 123, a digital/analog converter 125, and a source driver 127.

Due to the limitations of an output bandwidth of the general data bus GDBus, and a logic process on the read-out display data performed by the shift register 103, the operating speed of the entire system of the conventional display device becomes slow, so the conventional display device faces the challenge of operating speed. Under the trend of large-scale liquid crystal display panel, the data may be limited by the output architecture of the memory, thus negatively affecting the development of large-scale displays (e.g. large-scale LCD TV sets). Accordingly, relevant display manufacturers are in urgent need of solving the above problems.

### SUMMARY OF THE INVENTION

Accordingly, the present invention is directed to a memory and control apparatus for a display device. The memory and control apparatus comprises a sense-latch circuit, a display data bus, and a general data bus, and can make display data represented on the display data bus. The coupling of the sense-latch circuit and the display data bus can provide a path for the output of the display data.

The present invention is also directed to a memory for a display device. The memory comprises a display data bus and a general data bus, wherein the display data bus may provide a path for transmitting the display data output, and the general data bus may provide a path for the display device to access the memory.

The present invention provides a memory and control apparatus for a display device, which includes a memory, a sense-latch circuit, and a timing and memory controlling apparatus. The memory is used for storing data, and comprises a display data bus and a general data bus. The sense-latch circuit is coupled to the display data bus for sensing and latching the data on the display data bus. The timing and memory controlling apparatus is coupled to the memory and the sense-latch circuit, and the timing and memory controlling apparatus controls the memory to make the display data represent on the display data bus, and to make the sense-latch circuit output the data on the display data bus for displaying. When the display device intends to store the data in the memory, the data on the general data bus is stored to the memory.

According to an embodiment of the present invention, the memory includes a memory block and a selection sense I/O circuit. The memory block includes a plurality of memory cells and a plurality of bit lines, wherein the plurality of memory cells is used for storing data. The bit lines are coupled to the memory cells and the display data bus. The selection sense I/O circuit is coupled to the memory block and the general data bus for storing the data on the general data bus to the memory block or outputting the data stored in the memory block to the general data bus.

According to another embodiment of the present invention, a memory and control apparatus for a display device is provided, which includes a memory, a sense-latch circuit, and a timing and memory controlling apparatus. The memory includes a display data bus, a general data bus, a memory block, and a selection sense I/O circuit. The display data bus is used to provide a path for transmitting the display data to the outside of the memory. The general data bus is used to provide a path for the display device to access the memory. The memory block includes m rows of word lines, n columns of bit lines, and m*n memory cells, wherein m is a positive integer greater than or equal to 1. n columns of bit lines are coupled to the display data bus, where n is a positive integer greater than or equal to 1. m*n memory cells are arranged in a matrix for storing data, in which one of the memory cells is coupled between each row of word lines and each column of bit lines. The selection sense I/O circuit is coupled to the memory block and the general data bus for storing the data on the general data bus to the memory block, or outputting the data stored in the memory block to the general data bus. The sense-latch circuit is coupled to the display data bus for sensing and latching the data on the display data bus. The timing and memory controlling apparatus is coupled to the memory and the sense-latch circuit. The timing and memory controlling apparatus controls the memory to make the display data represent on the display data bus, and to make the sense-latch circuit output the data on the display data bus for displaying, in which when the display device intends to store data in the memory, the data on the general data bus is stored to the memory.

According to an embodiment of the present invention, a bus width of the display data bus is larger than a bus width of the general data bus.

According to an embodiment of the present invention, the memory has a structure of the display data bus and the general data bus so that the timing and memory controlling apparatus controls the memory to make the display data represent on the display data bus, and to make the sense-latch circuit output the data on the display data bus for displaying.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional data driving circuit for a display device.

FIG. 2 is a block diagram of a data driving circuit for a display device according to an embodiment of the present invention.

FIG. 3 is a circuit diagram of a memory of FIG. 2.

FIG. 4 is a schematic view of architecture of a data driving circuit for a display device according to another embodiment of the present invention.

FIGS. 5 to 7 are circuit diagrams of a memory and control apparatus for a display device according to another embodiment of the present invention.

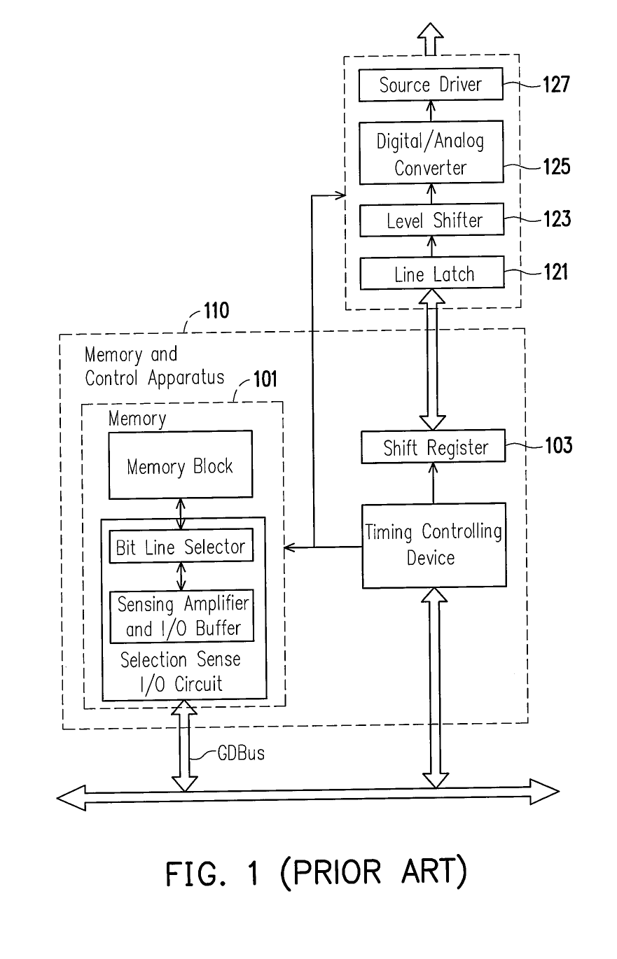

### DESCRIPTION OF EMBODIMENTS

In view of the conventional memory for a display device that only has a data output path, one of the main features of the present invention is that the memory has a path for transmitting the display data to the outside of the memory and a path for the display device to access the memory. Therefore, the memory has two transmission paths according to characteristics described in the following embodiments of the present invention, and the details will be described as follows.

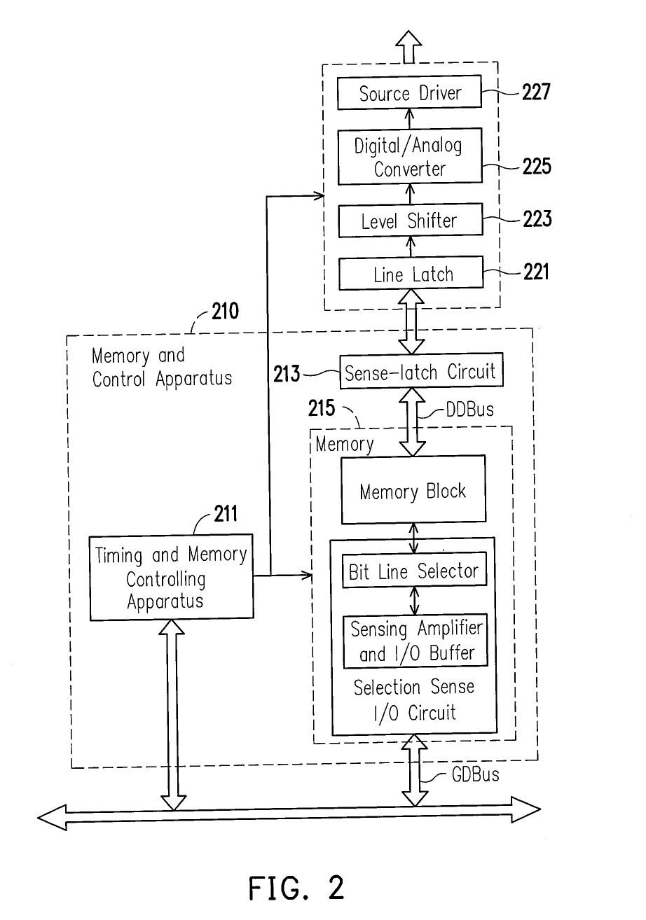

FIG. 2 is a block diagram of a data driving circuit for a display device according to an embodiment of the present invention. Referring to FIG. 2, the data driving circuit includes a source driver 227, a digital/analog converter 225, a level shifter 223, a line latch 221, and a memory and control apparatus 210. The present invention is different from the conventional art mainly in terms of the memory and control apparatus 210, while the circuits of other elements such as the source driver 227, the digital/analog converter 225, the level shifter 223, and the line latch 221 are similar to the conventional art, and will not be described herein.

In view of the above, in this embodiment, the memory and control apparatus 210 includes a memory 215, a sense-latch circuit 213, and a timing and memory controlling apparatus 211. The sense-latch circuit 213 is coupled between a display data bus DDBus and the line latch 221. The timing and memory controlling apparatus 211 is coupled to the memory 215 and the sense-latch circuit 213. Moreover, the memory 215 comprises a display data bus DDBus and a general data bus GDBus, and the memory 215 can be used to store data. The sense-latch circuit 213 is used to sense and latch the data on the display data bus DDBus, and to output the data on the display data bus DDBus when displaying. The timing and memory controlling apparatus 211 controls the memory 215, so as to make the display data represent on the display data bus DDBus, and to make the sense-latch circuit 213 output the data on the display data bus DDBus for displaying. When the display device intends to store data to the memory 215 or intends to read the data of the memory 215 according to external requirements, the general data bus GDBus is used as the path for transmitting data. The design of the general data bus GDBus is not significantly different from the general data bus of a common memory.

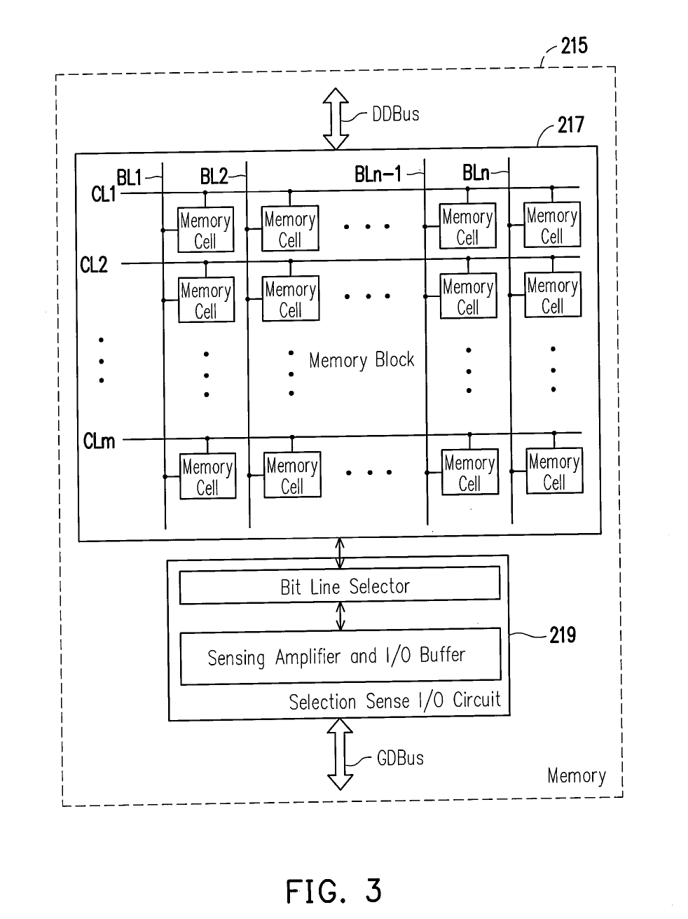

FIG. 3 illustrates a circuit structure of the memory 215 of FIG. 2 in detail. Referring to FIG. 3, the memory 215 includes a memory block 217 and a selection sense I/O circuit 219. The memory block 217 includes m*n memory cells, bit lines BL1-BLn, and word lines CL1-CLm, where m and n are positive integers greater than 1, and n columns of bit lines are coupled to the memory cells and the display data bus DDBus. The selection sense I/O circuit 219 is coupled between the memory block 217 and the general data bus GDBus. The m*n memory cells are used to store the data, and the selection sense I/O circuit 219 is used to store the data on the general data bus GDBus to the memory block 217, or to output the data stored in the memory block 217 to the general data bus GDBus.

Referring to FIGS. 2 and 3, it should be noted that the memory and control apparatus 210 has an independent path for transmitting the display data output, e.g. the display data bus DDBus and the sense-latch circuit 213 of FIG. 2. The path can transmit the data on n columns of bit lines to simultaneously output the data so that the above architecture can transmit the data of the memory 215 more quickly when displaying. Further, it should be noted that a bus width of the display data bus DDBus is larger than a bus width of the general data bus GDBus.

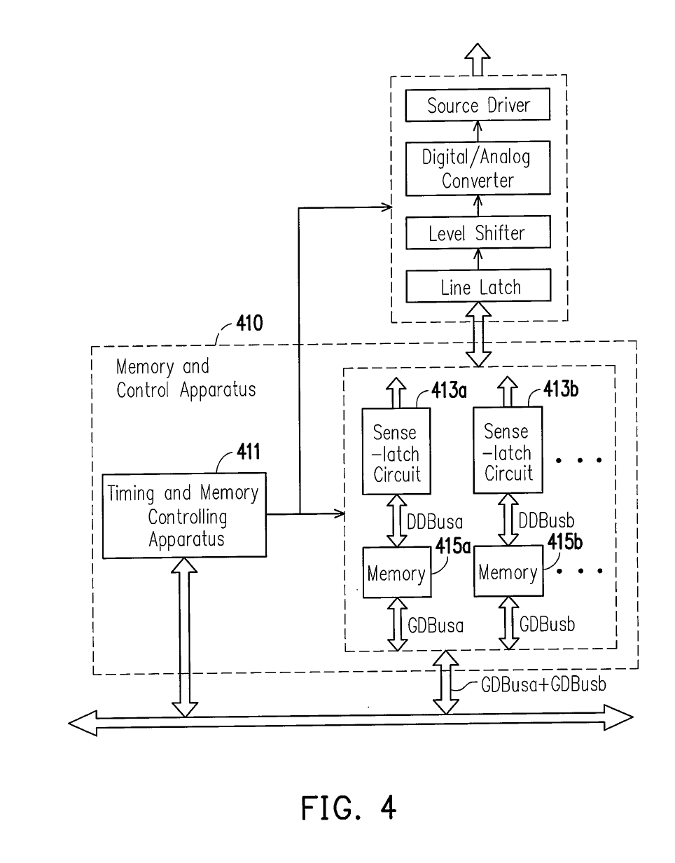

FIG. 4 is a schematic view of architecture of a data driving circuit for a display device according to another embodiment of the present invention. Referring to FIG. 4, a new architecture can be used, particularly under the circumstance that the current display device is developed towards large scale liquid crystal display panel. A memory and control apparatus 410 includes memories 415a and 415b, sense-latch circuits 413a and 413b, and a timing and memory controlling apparatus 411. Each memory is coupled to a sense-latch circuit, and has a display data bus and a general data bus. For example, a memory 413a has a display data bus DDBusa and a general data bus GDBusa, and a memory 415b has a display data bus DDBusb and a general data bus GDBusb. Those of ordinary skill in the art would appreciate that the numbers of the memories and the sense-latch circuits may be doubled, and would also appreciate that to double the output bandwidth is to output a corresponding display data in accordance with a pixel matrix of the display panel, such that the display data can be transmitted in two folds. The protection scope of the present invention is not limited to the above embodiment without departing from the spirit and the scope of the present invention.

In the embodiments of FIG. 2 and FIG. 4, a line latch is included in the data driving circuit. However, it should not limit the protection scope of the present invention. Those of ordinary skill in the art would know that the sense-latch circuit can build-in the line latch function. Therefore, the data driving circuit may not have a line latch.

In the next embodiment, the coupling relationship between different sense-latch circuits and memories, and how the sense-latch circuit outputs the data on the display data bus DDBus for displaying are further illustrated.

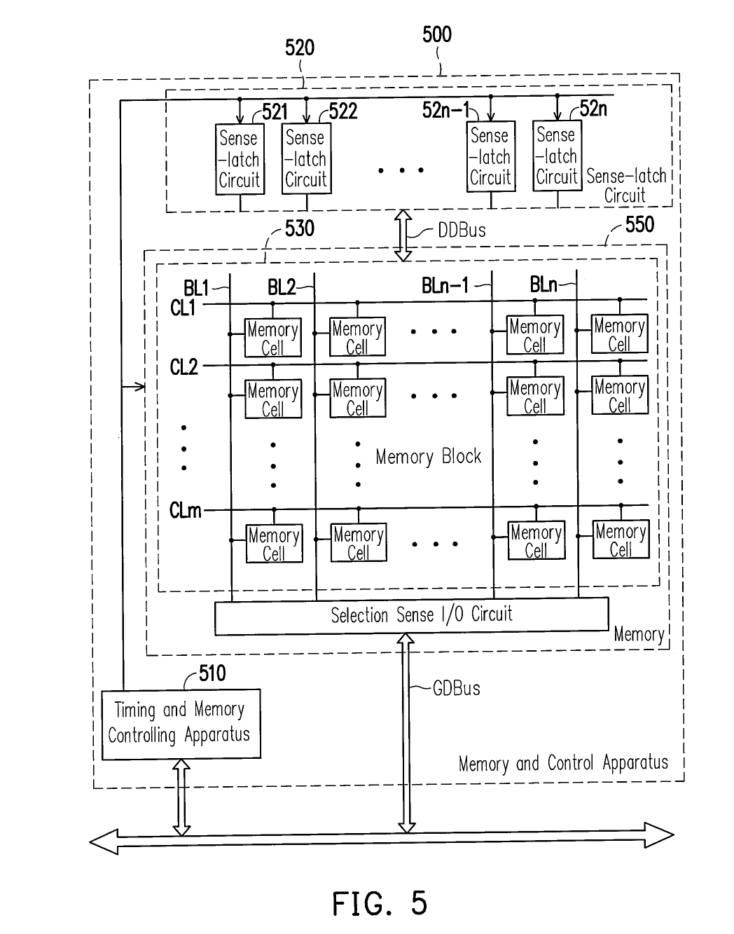

FIG. 5 is a circuit diagram of a memory and control apparatus for a display device according to another embodiment of the present invention. Referring to FIG. 5, a memory and control apparatus 500 includes a sense-latch circuit 520, a memory 550, and a timing and memory controlling apparatus 510. The timing and memory controlling apparatus 510 is coupled to the memory 550 and the sense-latch circuit 520. The structure of the memory 550 is same as the memory 215 of the embodiment of FIG. 3, and can refer to the description of the above embodiment, so the details will not be described herein again. The sense-latch circuit 520 includes sense latches 521-521n, each having an input end and an output end. The input end of each sense latch is coupled to one of the corresponding bit lines BL1-BLn through the display data bus DDBus. For example, an input end of a sense latch 521 is coupled to a bit line BL1, an input end of a sense latch 522 is coupled to a bit line BL2, and others are coupled in the same way until an input end of a sense latch 52n is coupled to a bit line BLn. When the timing and memory controlling apparatus 510 makes the display data represent on the display data bus DDBus, the sense latches 521-52n can output the data on the display data bus DDBus for displaying.

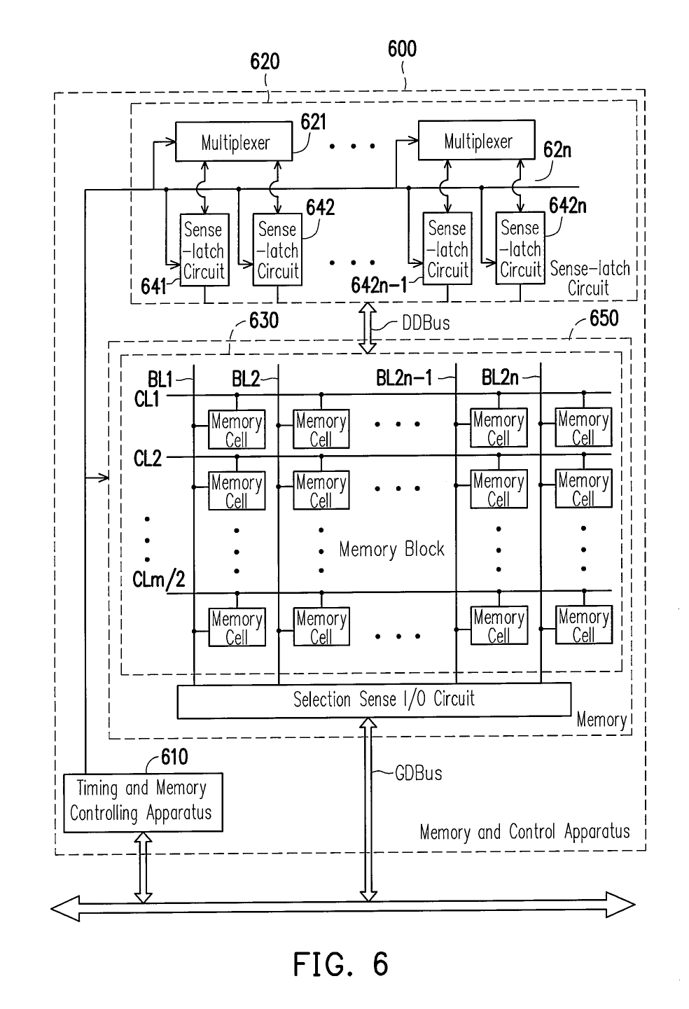

FIG. 6 is a circuit diagram of a memory and control apparatus for a display device according to another embodiment of the present invention. Referring to FIG. 6, a memory and control apparatus 600 includes a sense-latch circuit 620, a memory 650, and a timing and memory controlling apparatus 610. The timing and memory controlling apparatus 610 is coupled to the memory 650 and the sense-latch circuit 620. The structure of the memory 650 is similar to the memory 215 of the above embodiment of FIG. 3, and the memory block 630 also has m*n memory cells, except that the number of the word lines (CL1-CLm/2) is reduced to a half, and the number of the bit lines (BL1-B12n) is doubled. The sense-latch circuit 620 includes multiplexers 621-62n and sense latches 641-642n. Each sense latch (641-642n) has one input end and an output end, and the input end of each sense latch (641-642n) is coupled to one of the corresponding bit lines BL1-BL2n through the display data bus DDBus. For example, an input end of a sense latch 641 is coupled to a bit line BL1, an input end of a sense latch 642 is coupled to a bit line BL2, and others are coupled in the same way until an input end of a sense latch 642n is coupled to a bit line BL2n. Each multiplexer (621-62n) has two input ends and one output end, and an input end of each multiplexer is coupled to an output end of one of the corresponding sense latches 641-642n. For example, a first input end and a second input end of a multiplexer 621 are respectively coupled to an output end of a sense latch 641 and an output end of a sense latch 642, and a first input end and a second input end of a multiplexer 62n are respectively coupled to an output end of a sense latch 642n-1 and an output end of a sense latch 642n. When the timing and memory controlling apparatus 610 makes the display data represent on the display data bus DDBus, the multiplexers 621-62n can output the data on the display data bus DDBus for displaying.

It should be noted that in the above implementation method, if one batch of display data is n bit pixel data, when one row of the word lines CL1-CLm/2 is enabled, the sense latches 641-642n latch two batches of display data. As only one batch of display data is transmitted at a time, the mutliplexers 621-62n are used to switch the input ends, and another batch of display data is transmitted next time. Those of ordinary art in the art can use the combination of another kind of multiplexers and the sense latches to make the sense-latch circuit latching (reading) more than two batches of display data when one row of word lines is enabled as required, according to the spirit of the present invention and the teaching of the above embodiments.

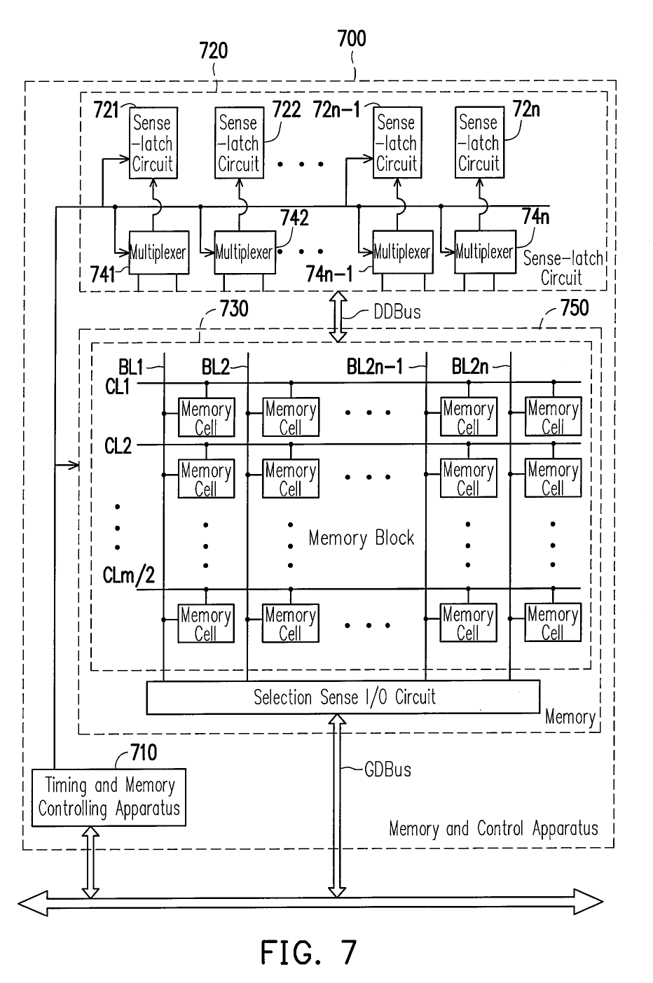

FIG. 7 is a circuit diagram of a memory and control apparatus for a display device according to another embodiment of the present invention. Referring to FIG. 7, a memory and control apparatus 700 includes a sense-latch circuit 720, a memory 750, and a timing and memory controlling apparatus 710. The timing and memory controlling apparatus 710 is coupled to the memory 750 and the sense-latch circuit 720. The structure of the memory 750 is same as the memory 620 of the above embodiment of FIG. 6. The memory block 730 has m*n memory cells, m/2 rows of word lines (CL1-CLm/2), and 2n columns of bit lines (BL1-BL2n), where m/2 and n are positive integers greater than 1. The sense-latch circuit includes sense latches 721-721n and multiplexers 741-74n. Each multiplexer (741-74n) has two input ends and one output end, and each input end of each multiplexer is coupled to one of the corresponding bit lines Bla1-BLn2 through the display data bus DDBus. For example, a first input end and a second input end of a multiplexer 741 are respectively coupled to bit lines BL1 and BL2, a first input end and a second input end of a multiplexer 74n are respectively coupled to bit lines BL2n-1 and BL2n. Each sense latch (721-72n) has an input end and an output end, and the input end of each sense latch and an output end of one of the corresponding multiplexers 741-74n are for example coupled respectively. An input end of a sense latch 721 is coupled to an output end of a multiplexer 741, an input end of a sense latch 722 is coupled to an output end of a multiplexer 742, and an input end of a sense latch 72n is coupled to an output end of a multiplexer 74n. When the timing and memory controlling apparatus 710 makes the display data represent on the display data bus DDBus, the sense latches 721-72n output the data on the display data bus for displaying.

In the above implementation method, if one batch of display data is n bit pixel data, when one row of the word lines CL1-CLm/2 is enabled, a memory capacity of the row of word lines and 2n columns of bit lines is equal to two batches of display data. Only one batch of display data is transmitted at a time, so the multiplexers 741-74n first switch to select n columns of bit lines to transmit a first batch of display data, and then switch to select other n columns of bit lines to transmit a second batch of display data. Those of ordinary art in the art can use the combination of another type of multiplexers and the sense latches to make the sense-latch circuit transmit more than two batches of display data when one row of word lines is enabled as required, according to the spirit of the present invention and the teaching of the above embodiments.

To sum up, in the memory and control apparatus of the embodiments of the present invention, the memory has a structure of a display data bus and a general data bus. Therefore, the timing and memory controlling apparatus controls the memory to make the display data represent on the display data bus, and to make the sense-latch circuit output the data on the display data bus for displaying. The memory and control apparatus provided by the present invention has at least the following advantages.

1. The display data has an independent output path, and will not be limited by the output bandwidth of the general data bus.

2. The display data can be directly read out by bit lines and latched on the sense-latch circuit, so that the wiring space can be reduced and the circuit area on circuit layout can be reduced.

3. When one row of word lines is enabled, multiple batches of display data can be read at a time, thereby reducing the times of enabling the word lines and decreasing the power consumption.

4. The data is quickly latched on the sense-latch circuit, thereby improving the operating speed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory and control apparatus for a display device, comprising:
a memory, for storing data, comprising a display data bus and a general data bus;
a sense-latch circuit, coupled to the display data bus, for sensing and latching data on the display data bus; and
a timing and memory controlling apparatus, coupled to the memory and the sense-latch circuit, for controlling the memory to make a display data represent on the display data bus and to make the sense-latch circuit output the data on the display data bus for displaying;
wherein when the display device intends to store the data in the memory, the data on the general data bus is stored to the memory.

2. The memory and control apparatus for a display device as claimed in claim 1, wherein the memory comprises:
a memory block, comprising:
a plurality of memory cells, for storing data; and
a plurality of bit lines, coupled to the memory cells and the display data bus; and
a selection sense I/O circuit, coupled to the memory block and the general data bus, for storing the data on the general data bus to the memory block or outputting the data stored in the memory block to the general data bus.

3. The memory and control apparatus for a display device as claimed in claim 1, wherein a bus width of the display data bus is larger than a bus width of the general data bus.

4. The memory and control apparatus for a display device as claimed in claim 2, wherein the sense-latch circuit comprises a plurality of sense latches each having an input end and an output end, the input end of each sense latch is coupled to one of the corresponding bit lines through the display data bus, when the timing and memory controlling apparatus makes the display data represent on the display data bus, the sense latches output the data on the display data bus for displaying.

5. The memory and control apparatus for a display device as claimed in claim 2, wherein the sense-latch circuit comprises:
a plurality of sense latches, each having an input end and an output end, the input end of each sense latch being coupled to one of the bit lines through the display data bus; and
a plurality of multiplexers, each having a plurality of input ends and an output end, the input ends of each multiplexer being coupled to the output end of one of the sense latches;
wherein when the timing and memory controlling apparatus makes the display data represent on the display data bus, the multiplexers output the data on the display data bus for displaying.

6. The memory and control apparatus for a display device as claimed in claim 5, wherein a number of the multiplexers is less than or equal to a number of the sense latches.

7. The memory and control apparatus for a display device as claimed in claim 2, wherein the sense-latch circuit comprises:
a plurality of multiplexers, each having a plurality of input ends and an output end, each input end of each multiplexer being coupled to one of the corresponding bit lines through the display data bus; and
a plurality of sense latches, each having an input end and an output end, the input end of each sense latch being coupled to the output end of one of the corresponding multiplexers;
wherein when the timing and memory controlling apparatus makes the display data represent on the display data bus, the sense latches output the data on the display data bus for displaying.

8. A memory and control apparatus for a display device, comprising:
a memory, comprising:
a display data bus, used to provide a path for transmitting a display data to an external of the memory;
a general data bus, used to provide a path for the display device to access the memory;
a memory block, comprising:
m rows of word lines, wherein m is a positive integer greater than or equal to 1;
n columns of bit lines, coupled to the display data bus, wherein n is a positive integer greater than or equal to 1;
m*n memory cells, arranged in a matrix, for storing data, wherein one of the memory cells is coupled between each row of word lines and each column of bit lines;
a selection sense I/O circuit, coupled to the memory block and the general data bus, for storing the data on the general data bus to the memory block, or outputting the data stored in the memory block to the general data bus;
a sense-latch circuit, coupled to the display data bus, for sensing and latching the data on the display data bus; and
a timing and memory controlling apparatus, coupled to the memory and the sense-latch circuit, and controlling the memory to make the display data represent on the display data bus and to make the sense-latch circuit outputting the data on the display data bus for displaying;
wherein when the display device intends to store the data in the memory, the data on the general data bus is stored to the memory.

9. The memory and control apparatus for a display device as claimed in claim 8, wherein a bus width of the display data bus is larger than a bus width of the general data bus.

10. The memory and control apparatus for a display device as claimed in claim 8, wherein the sense-latch circuit comprises a plurality of sense latches, each having an input end and an output end, the input end of each sense latch is coupled to one of the corresponding bit lines through the display data bus, when the timing and memory controlling apparatus makes the display data represent on the display data bus, the sense latches output the data on the display data bus for displaying.

11. The memory and control apparatus for a display device as claimed in claim 9, wherein the sense-latch circuit comprises:
a plurality of sense latches, each having an input end and an output end, the input end of each sense latch being coupled to one of the bit lines through the display data bus; and
a plurality of multiplexers, each having a plurality of input ends and an output end, the input ends of each multiplexer being coupled to the output end of one of the sense latches;
wherein when the timing and memory controlling apparatus makes the display data represent on the display data bus, the multiplexers output the data on the display data bus for displaying.

12. The memory and control apparatus for a display device as claimed in claim 11, wherein a number of the multiplexers is less than or equal to a number of the sense latches.

13. The memory and control apparatus for a display device as claimed in claim 8, wherein the sense-latch circuit comprises:
a plurality of multiplexers, each having a plurality of input ends and an output end, each input end of each multiplexer being coupled to one of the corresponding bit lines through the display data bus; and
a plurality of sense latches, each having an input end and an output end, the input end of each sense latch is coupled to the output end of one of the corresponding multiplexers;
wherein when the timing and memory controlling apparatus makes the display data represent on the display data bus, the sense latches output the data on the display data bus for displaying.

14. A memory for a display device, comprising:
a display data bus, for providing a path for transmitting the display data to the outside of the memory;
a general data bus, for providing a path for the display device to access the memory;
a memory block, comprising:
m rows of word lines, wherein m is a positive integer greater than or equal to 1;
n columns of bit lines, coupled to the display data bus, where n is a positive integer greater than or equal to 1;
m*n memory cells, arranged in a matrix, for storing the data, wherein one of the memory cells is coupled between each row of word lines and each column of bit lines; and
a selection sense I/O circuit, coupled to the memory block and the general data bus, for storing the data on the general data bus to the memory block, or outputting the data stored in the memory block to the general data bus.

15. The memory for a display device as claimed in claim 14, wherein a bus width of the display data bus is larger than a bus width of the general data bus.
